(19) United States
(12) Patent Application Publication
(10) Pub. No.: US 2014/0156975 A1
(43) Pub. Date: Jun. 5, 2014

(54) Redundant Threading for Improved Reliability

(71) Applicant: ADVANCED MICRO DEVICES, INC., Sunnyvale, CA (US)

(72) Inventors: Vilas SRIDHARAN, Brookline, MA (US); James M. O'Connor, Austin, TX (US); Steven K. Reinhardt, Vancouver, WA (US); Nuwan S. Jayasena, Sunnyvale, CA (US); Michael J. Schulte, Austin, TX (US); Dean A. Liberty, Nashua, NH (US)

(73) Assignee: Advanced Micro Devices, Inc., Sunnyvale, CA (US)

(21) Appl. No.: 13/690,841

(22) Filed: Nov. 30, 2012

(51) Int. Cl. G06F 9/30

(52) U.S. Cl. CPC G06F 9/30021
USPC 712/227

(57) ABSTRACT

In some embodiments, a method for improving reliability in a processor is provided. The method can include replicating input data for first and second lanes of a processor, the first and second lanes being located in a same cluster of the processor and the first and second lanes each generating a respective value associated with an instruction to be executed in the respective lane, and responsive to a determination that the generated values do not match, providing an indication that the generated values do not match.

### BACKGROUND

1. Field

Embodiments described herein generally relate to increasing reliability in processing devices.

2. Background Art

Many high performance systems include multiple processing devices operating in parallel. For example, some of these systems include arrays of graphics processing units (GPUs). Though the probability that these GPUs will develop errors in their processing is relatively insignificant for each particular GPU, the aggregate probability can be enough to cause serious degradations in performance. These errors can be caused by errors in the processing logic as well as the presence of noise.

A number of different approaches have been implemented to detect and, sometimes, correct for errors in a processing device. For example, error correcting code (ECC) and parity approaches add bits to data. These additional bits are then used to check the payload of the data. Although these approaches have been effective at reducing errors, they have a number of drawbacks. In particular, both of these approaches require large amounts of additional hardware and require the consumption of large amounts of power.

Other approaches have focused on system-level redundancy. In these approaches, the system submits a task to be completed twice and the results compared to determine whether an error is present. The processing of these redundant tasks can be done serially or in parallel. Moreover, in the special case of single instruction, multiple data (SIMD) devices, redundant processing can take the form of cluster level redundancy.

### SUMMARY OF THE EMBODIMENTS

Embodiments described herein generally relate to the use of wavefront and/or lane level redundancy in a processor to increase reliability. For example, in some embodiments, a method for improving reliability in a processor is provided. The method can include replicating input data for first and second lanes of a processor, the first and second lanes being located in a same cluster of the processor and the first and second lanes each generating a respective value associated with an instruction to be executed in the respective lane, and responsive to a determination that the generated values do not match, providing an indication that the generated values do not match. In some embodiments, a system for improving reliability in a processor is provided. The system includes a scheduler configured to replicate input data for first and second lanes of a processor, the first and second lanes being located in the same cluster of the processor and each of the first and second lanes generating a respective value associated with an instruction to be executed in the respective lane and a comparator configured to compare the generated values.

In some embodiments, a method for improving reliability in a processor is provided. The method includes generating at least one mirrored wavefront having state identical to state of a first wavefront, each of the first wavefront and the at least one wavefront generating a value associated with an instruction to be executed therein, and responsive to a determination that the generated values do not match, providing an indication that the generated values do not match. In some embodiments, a system for improving reliability in a processor is provided. The system includes a scheduler configured to generate at least one mirrored wavefront having state identical to state of a first wavefront, each of the first wavefront and the at least one wavefront generating a value associated with an instruction to be executed therein and a comparator configured to compare the generated values.

These and other advantages and features will become readily apparent in view of the following detailed description. Note that the Summary and Abstract sections may set forth one or more, but not all example embodiments of the disclosed subject matter as contemplated by the inventor(s).

### BRIEF DESCRIPTION OF THE DRAWINGS/FIGURES

The accompanying drawings, which are incorporated herein and form a part of the specification, illustrate the disclosed subject matter and, together with the description, further serve to explain the principles of the contemplated embodiments and to enable a person skilled in the pertinent art to make and use the contemplated embodiments.

FIG. 1 is a block diagram illustration of a processor, according to some embodiments.

FIG. 2 is a block diagram illustration of a cluster, according to some embodiments.

FIG. 3 is a block diagram illustration of a processor, according to some embodiments.

FIGS. 4-5 are flowchart of methods of increasing reliability in a processor, according to some embodiments.

FIG. 6 illustrates an example computer system in which embodiments, or portions thereof, may be implemented as computer-readable code.

The disclosed subject matter will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

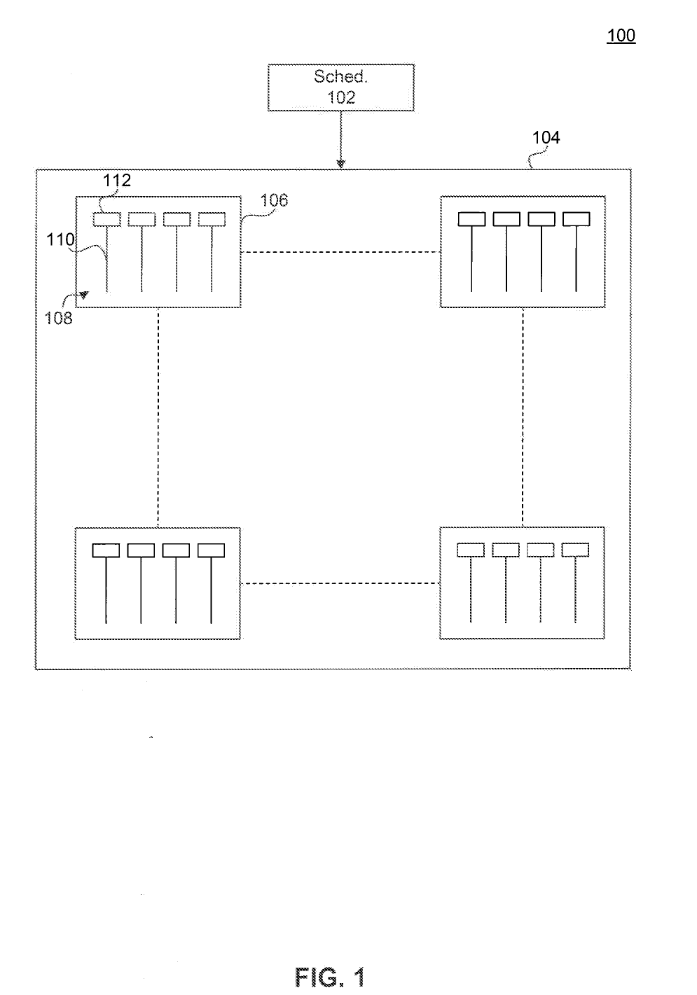

FIG. 1 shows a functional block diagram of a processor 100, according to some embodiments. As shown in FIG. 1, processor 100 includes a scheduler 102 and a processing core 104. Processing core 104 includes an array of clusters 106. Each of clusters 106 includes a set of lanes 108. In one implementation, a lane of a processor includes processing components that complete instructions based on operands stored in registers.

For example, in the implementation shown in FIG. 1, each of clusters 106 includes four lanes 108. As would be appreciated by those skilled in the relevant art based on the description herein, different implementations can include a different number of lanes per cluster. Each lane 108 includes a data path 110 and a register file 112. Register files 112 include instructions and operands for instructions executed by data path 110. Moreover, once data path 110 completes an instruction, it writes the result of the instruction back to a respective register file 112. In one implementation, each of data paths 110 can include a processing device that executes an instruction stored in register file 112 using operands stored in register file 112. As would be appreciated by those skilled in the relevant art based on the description herein, each of cluster 106 can include additional components (e.g., shared specialized processing units).

Processor 100 can be a multi-threaded single instruction stream, multiple data stream (SIMD) device. In such an implementation, one or more clusters of clusters 106 execute the same instruction stream on different data. For example, a kernel can be dispatched to processor 100. A kernel is a function including instructions declared in a program and to be executed on processor 100. The instructions of the kernel are executed in parallel by one or more of clusters 106. The kernel is associated with a work group. Each work group includes a plurality of work items, each of which is an instantiation of a kernel function. For example, in FIG. 1, one or more of clusters 106 can be used to execute instructions of a kernel in parallel. In such an implementation, each of lanes 108 of processing core 104 can execute the same instruction in a given clock cycle. Lanes 108, however, each have a different work item identifier, and thereby execute the instructions on different data. The number of work items being associated with a single work group of a kernel being processed in parallel is described herein as a wavefront. The width of the wavefront, i.e., the number of work items that are being processed in parallel, is a characteristic of processing core 104. Thus, processor 100 can be especially advantageous for applications that require a relatively large amount of parallel processing. For example, processor 100 can be a graphics processing unit (GPU) that executes graphics processing applications, which often include a great deal of parallel processing (e.g., pixel operations).

Large servers and other high performance systems often include a number of processors similar to processor 100 so as to be able to service the needs of a number of different clients. These high performance devices, however, often also require high reliability. In particular, processing necessarily includes a non-zero probability of the presence of errors. These errors can come from a variety of sources, e.g., logic errors or the presence of noise. Although the probability of an error in any one processor can be relatively insignificant, when a number of processors are used together, e.g., in a high performance device, the combined probability of an error rises to a significant level. In other implementations, however, the probability of error in one processor may be significant.

To address these errors, a number of different options have been used. For example, two approaches often implemented are error correcting code (ECC) and parity. Both of these approaches are often implemented as additional hardware that can detect and, sometimes, correct internal data corruption. More specifically, both of these approaches rely on additional bits included in data that are used to check the rest of the data bits. These approaches, however, result in additional hardware space being used in processor 100 and can result in a great deal of additional power being consumed by processor 100.

Other error detection and correction schemes utilize redundant processing. For example, at a system level, a series of instructions can be repeated and the results between the two can be compared to determine whether an error is present. This approach, however, is inconvenient because it requires an application to submit multiple kernels to processor 100 so the results can be compared. Another approach is to execute two identical kernels in parallel and compare results. This approach also suffers from inconvenience in terms of an application having to submit two kernels.

In embodiments described herein, an approach to improve reliability is provided that uses lane level and/or wavefront level redundancy to address errors. For example, in an embodiment, an application can request different levels of reliability. In a high reliability mode, an application can choose whether to employ wavefront level and/or lane level redundancy to improve reliability. Moreover, the application can also select the level of wavefront and/or thread level redundancy used to detect and/or correct for errors. Through the use of lane level and/or wavefront level redundancy, space on a board can be freed up for other devices instead being used for error detection and/or correction (e.g., using ECC or parity techniques). Moreover, lane and/or wavefront level redundancy, as described in some embodiments of the present disclosure, also can reduce the complexity of implementation of error detection or correction techniques. In particular, relatively large portions of a processor can be protected from errors through the use of a single technique (e.g., lane and/or wavefront level redundancy) without having to deploy a number of different resources for each region of the processor. Furthermore, power consumption can be reduced in some embodiments of the present disclosure because redundant computation can be activated based on requests received from an application.

For example, in some embodiments, an application can select lane level redundancy in which two or more adjacent lanes of a cluster execute instructions on the same data. At a predetermined instruction, e.g., at each store instruction and/or an atomic update instruction, a value generated by each lane (e.g., a memory address and/or data to written to the memory address) can be compared. If the values match, processing can continue. If the values do not match, however, an indication that the values did not match can be provided. In some embodiments, providing this indication can include taking different types of actions. For example, “active” actions such as raising an exception or performing majority voting can be performed. Additionally or alternatively “passive” actions, such as setting a flag or incrementing a counter can be performed. In some embodiments, one or more specific action can be tailored to the instruction(s) that triggered the comparison and/or can be specified by the application. Additionally or alternatively, action taken can also include re-synchronizing wavefront(s) or lane(s) or deploying additional wavefront(s).

Additionally, or alternatively, an application can specify that wavefront level redundancy should be used to improve reliability. For example, if an application requests wavefront level redundancy, a scheduler can generate one or more mirrored wavefronts. The wavefront and the mirrored wavefronts are then deployed in a processing core. When all the wavefronts reach a predetermined instruction, a value generated by each wavefront is compared. If the values match, processing is allowed to continue. If not, an indication can be provided.

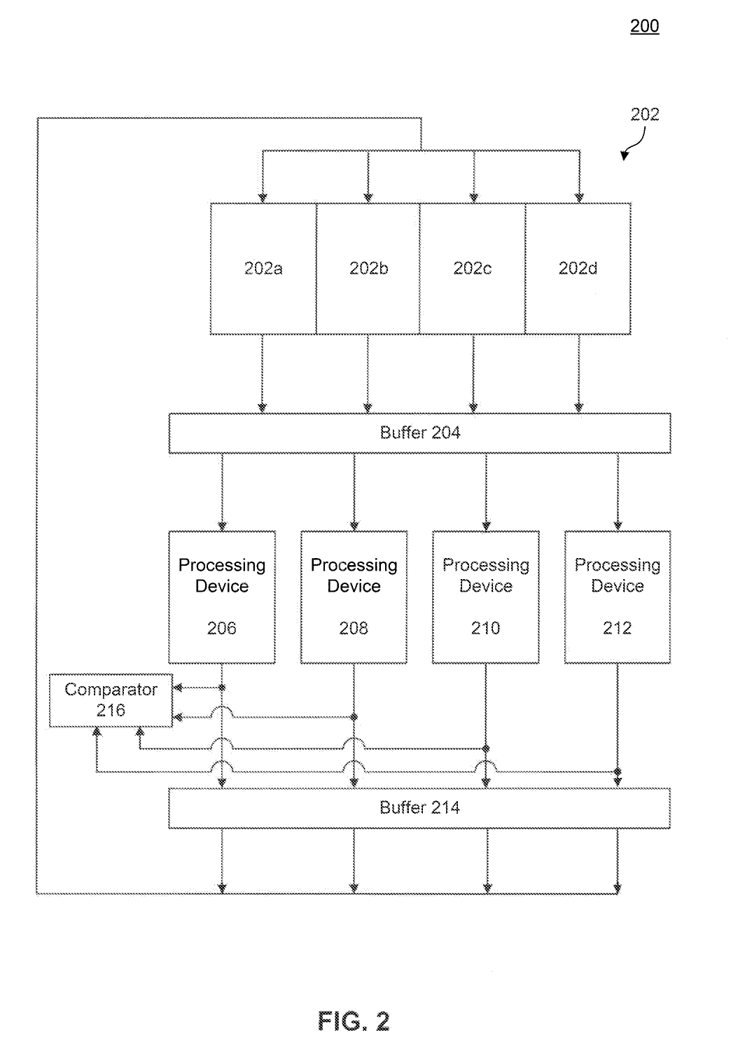

FIG. 2 shows a functional block diagram of a cluster 200, according to some embodiments. As shown in FIG. 2, cluster 200 includes a register file 202 including portions 202A, 202B, 202C, and 202D, buffers 204 and 214, processing devices 206-212, and a comparator 216.

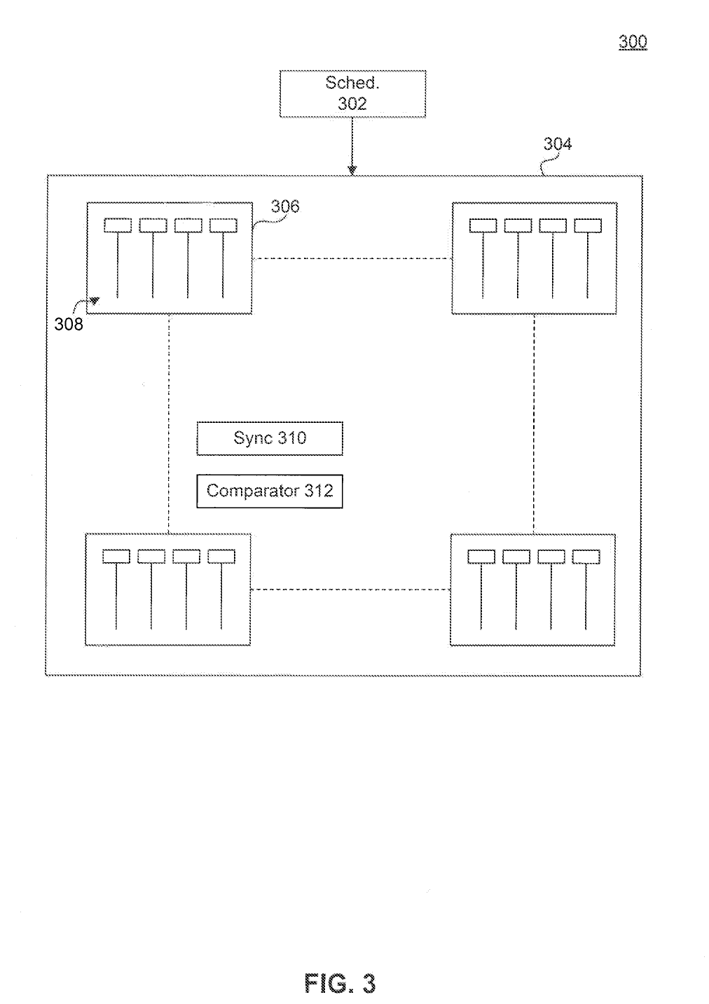

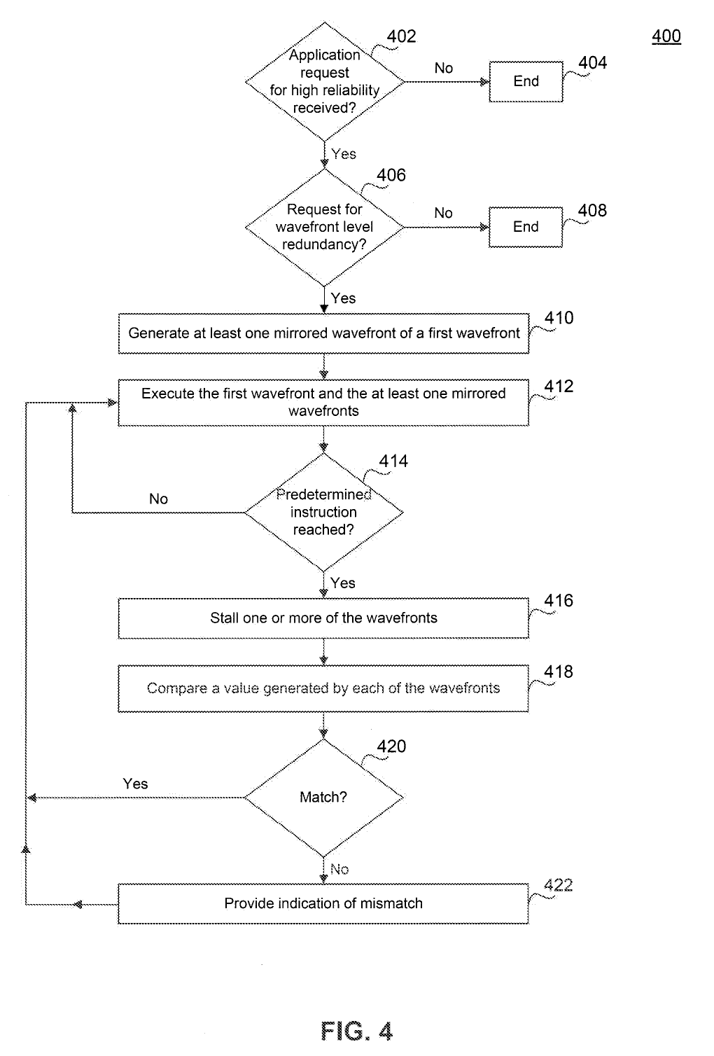

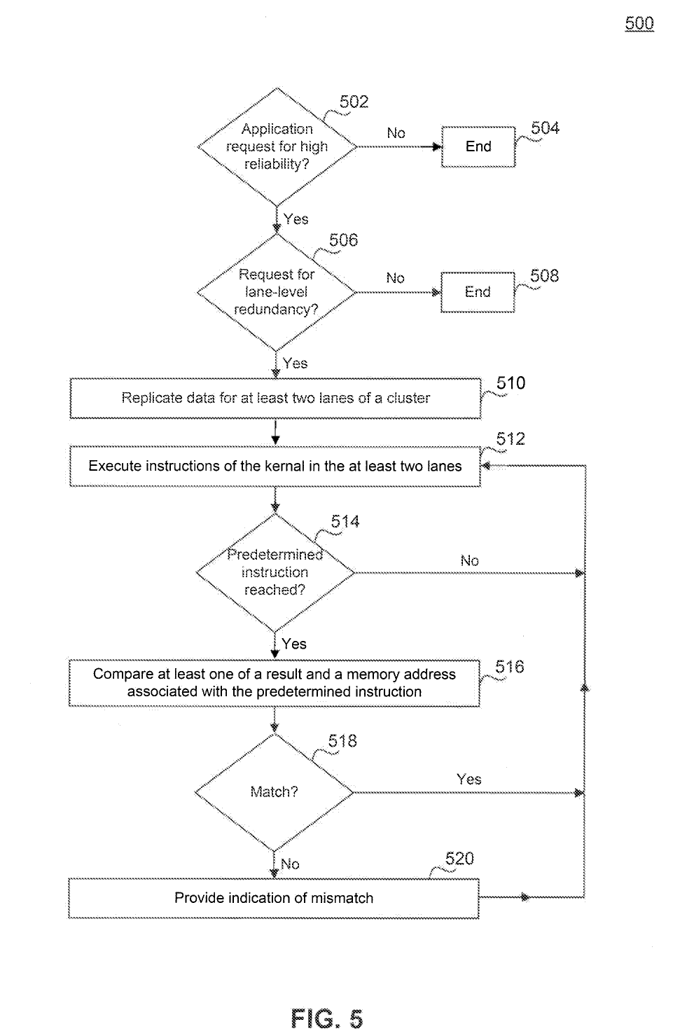

FIG. 3 shows a functional block diagram of a processor 300, according to some embodiments. Processor 300 includes a scheduler 302, a processing core 304, clusters 306, lanes 308, a sync module 310, and a comparator 312. In some embodiments, clusters 306 are implemented as shown in FIG. 2. For example, one of lane 308 can be implemented as one of processing devices 206-210 and respective portions of register file 202 and buffers 204 and 214. The operation of processor 300 will be described in greater detail with respect the flowcharts shown in FIGS. 4 and 5.

FIG. 4 shows a flowchart depicting a method 400 for improving reliability in a processor, according to some embodiments. In one example, method 400 may be performed by the systems shown in FIGS. 2-3. Not all steps may be required, nor do all the steps shown in FIG. 4 necessarily have to occur in the order shown.

In step 402, it is determined whether an application has requested for high reliability. For example, an application programming interface (API) can be provided to a software developer for use with processor 300. When an application provided by a software developer requests a kernel to be executed on processor 300, the request can include a request for high reliability. Thus, the functionality described in embodiments described herein for improving reliability can be activated by the application on kernel by kernel basis based on whether the application requires high reliability for the particular data kernel being executed. If no request for higher reliability is received, flowchart 400 proceeds to step 404 and ends.

In step 406, it is determined whether a request for wavefront level redundancy has been received. As described above, an API can be provided to a software developer, allow the software developer to request high reliability. This API can also allow the software developer to choose a particular type of redundancy that is most efficient for the application. For example, the application can request wavefront level redundancy as a way to improving reliability. As described below, the API can also allow the software developer to select a particular type of wavefront redundancy (e.g., error detection or majority of voting). The degree to which wavefront level redundancy is used to correct and/or detect errors (e.g., measured in the number of generated mirrored wavefronts) can also be determined by the application. If a request for wavefront level redundancy is not received, the flowchart 400 ends at step 408.

In step 410, at least one mirrored wavefront of a first wavefront is generated. For example, in FIG. 3, scheduler 302 can generate at least one mirrored wavefront of a first wavefront. For example, upon receiving a kernel to be executed by processor 300, scheduler 302 can generate a first wavefront to be deployed into processing core 304. To generate the at least one mirrored wavefronts, scheduler 302 can generate additional wavefront(s) having state identical to the state of the first wavefront. In some embodiments, scheduler 302 can deploy the mirrored wavefront(s) immediately after the first wavefront so as to reduce synchronization issues between the first and the mirrored wavefronts.

Moreover, based on the request for wavefront level redundancy, scheduler 302 can generate more than one mirrored wavefront. As would be appreciated by those skilled in the relevant arts based on the description herein, the level of reliability increases with the amount of redundancy. Thus, to increase the level of reliability, two or more mirrored wavefronts can be generated. Moreover, generating two or more mirrored wavefronts can also allow for majority voting and thereby allow for correction as well as error detection.

The generating of the at least one wavefront mirrored with respect to the first wavefront is an operation that is invisible to the application. Thus, the application is not aware that the wavefront level redundancy is being executed. However, as will be described below, in some embodiments, if an error is detected, an exception is raised. In some embodiments, the application is required to respond to the raised exception. In some embodiments, the operating system is able to respond to the raised exception (e.g., by terminating the application), and thus the application may not be required to be aware of the wavefront level redundancy or to be able to respond to the exception.

In step 412, the first wavefront and the at least one mirrored wavefronts are executed. For example, in FIG. 3, the first wavefront and the at least one mirrored wavefronts can be executed using processing core 304.

In step 414, it is determined whether the first wavefront or any of the at least one mirrored wavefronts has reached a predetermined instruction. For example, in FIG. 3, sync module 310 can be configured to determine whether the first wavefront or any of the at least one mirrored wavefronts has reached the predetermined instruction. In some embodiments, the predetermined instruction is a store or automatic atomic update instruction.

If a wavefront has reached the predetermined instruction, step 416 is reached. In step 416, one or more of the wavefronts is stalled. For example, in FIG. 3, during processing, the first wavefront and the mirrored wavefront(s) may fall out of synchronization. Thus, one of the wavefronts may reach the predetermined instruction before the others. For example, because the first wavefront is issued first by the scheduler 302, the first wavefront may be the first to reach the predetermined instruction. In these instances, the first wavefront and any other of the at least one mirrored wavefronts that have reached the predetermined instruction can be stalled until all of the wavefronts have reached the predetermined instruction. In some embodiments, processing core 304 simultaneously processes between 32 and 40 wavefronts. Thus, the delay between different wavefronts can be relatively confined to a relatively small number of processing cycles, thereby reducing the size of sync module 310.

In some embodiments, instead of implementing a sync module 310, each of the wavefronts is instead configured to stall on their own at the predetermined instruction until all the wavefronts have reached the instruction. For example, a compiler or finalizer can insert instructions into the kernel that requires each of the wavefronts to stall until all the wavefronts have reached a predetermined instruction.

In step 418, a value generated by each of the wavefronts is compared. For example, the predetermined instruction can be a store instruction. During processing, each of the wavefronts can generate two values associated with the store instruction: an address to be written and data to be written to that address. Thus, in step 418, the address to be written and/or the data to be written to that address may be compared. Because each of the wavefronts process identical instructions on identical data, the memory address and data ideally would be equal. Moreover, in some embodiments, the value(s) compared at step 418 can be retrieved directly from processing devices 206-212 or can be retrieved from portions of register file 202. If the values are not equal, however, an error is determined to be present at step 420.

If an error is determined to be present, step 422 is reached and an indication that a mismatch has occurred is provided. An indication that a mismatch has occurred can include a variety of different actions. For example, comparator 320 can take “active” steps, such as raising an exception or performing majority voting, or “passive” steps such as setting a flag or incrementing a counter. The specific action taken(s) can be determined based on the instruction that triggered the comparison and/or specified by an application. For example, an application can specify that “active” steps be taken when one set of instructions are reached (e.g., one or more store instructions or all store instructions) and “passive” steps be taken when another set of instructions are reached (e.g., one or more specific computation instructions or all other instructions). Moreover, the action(s) taken can also include restoring synchronization (e.g., through the use of buffer 214 to buffer results of one or more of processing devices 206-210) between the different lanes of cluster 200.

If the application requests that an exception be raised when an error is detected, comparator 320 raises an exception that is communicated to the application. In such an embodiment, the application may require that processing continue from the last point out of which there was not an error. For example, processor 300 can include “roll back” functionality that provides checkpoints at different execution points. This roll back functionality can be used to return execution to the last checkpoint at which no error was present.

In majority voting, on the other hand, comparator 320 can first determine whether a majority value is determinable. For example, in an embodiment in which two mirrored wavefronts are generated, a majority value is determinable if two of the values match. If so, the store instruction can be allowed to proceed in either of the two wavefronts in which the majority value was generated.

If the majority cannot be determined, however, e.g., because all of the values are different, then an exception can be generated which is addressed by the application, as described above. In some embodiments, once the exception is addressed and/or majority voting performed, execution of the wavefronts is allowed to continue.

In some embodiments, actions taken when an indication of mismatch is provided can also include generating new wavefronts or copying the state of one or more wavefronts for other wavefront(s). For example, if majority voting is performed and a majority value is identified, the state of the wavefronts that generated the majority value can be replicated for the wavefront(s) that did not generate the majority value.

FIG. 5 shows a flowchart depicting a method 500 for improving reliability in a processor, according to some embodiments. In one example, method 500 may be performed by the systems shown in FIGS. 2-3. Not all steps may be required, nor do all the steps shown in FIG. 5 necessarily have to occur in the order shown.

In step 502, it is determined whether an application has requested for high reliability. In some embodiments, step 502 can be substantially similar to step 402 described with reference to FIG. 4. If a request for high reliability is not received, flowchart 500 ends at step 504.

In step 506, it is determined whether lane level redundancy has been requested by the application. For example, as described above, an API can be provided to the software developer that allows the software developer to specify the type and level of redundancy provided. If the application does not request lane level redundancy, flowchart 500 ends at step 508.

In step 510, input data for at least two lanes of a cluster is replicated. In some embodiments, the input data for the at least two lanes is replicated by providing identical work item identifiers for each of the at least two lanes. For example, with reference to FIG. 2, input for lanes including processing devices 206 and 208 can be replicated. For example, in some embodiments, scheduler 302 (or other component of processor 300) can be used to assign work item identifiers to the different lanes of a cluster. The work item identifier specifies the data on which each lane will perform its respective instruction stream. To replicate the input data for two or more lanes, scheduler 302 can provide identical work item identifiers to the two or more lanes that are involved in the redundant processing. In some embodiments, the instructions executed by processing devices 206 and 208 are identical. Thus, executing the same instruction with the same data, processing cores 206 and 208 should come to the same result. As will be described below, if the results are not equal, the system determines that an error is present.

In some embodiments, the application can request for more than two lanes of a cluster to have the same input data. As described above, when additional redundancy is implemented into the system, generally the reliability that the system can provide increases. For example, the application can request that the lane including processing device 210 also provide redundancy. Moreover, by using three lanes for redundancy, a majority can be determined thereby allowing for majority voting error correction.

In contrast to the wavefront level redundancy provided in FIG. 4, the lane level redundancy provided in FIG. 5 is visible to the application. As would be appreciated by those skilled in the relevant art based on the description herein, processor 300 provides a certain number of resources that can be used to process work items. For example, processor 300 can support 256 work items. However, when implementing lane level redundancy using two lanes, the number of work items that can be handled by processor 300 would instead be 128 work items.

In some embodiments, lane level redundancy can be made invisible to an application by doubling the number of lanes included in processing core 304. Thus, when redundancy is implemented, the expected number of lanes would be available for the application (e.g., support for 256 work items). When applications do not require high level reliability, the system would use the extra lanes to process other work groups.

In step 512, instructions are processed in the at least two lanes. For example, in FIG. 2, processing devices 206 and 208 can process instructions retrieved from register file portions 202A and 202B. Processing devices 206 and 208 can process the instructions on operands received from respective register file portions 202A and 202B. Before these operands are received by processing cores 206 and 208, they can be held in buffer 204.

In step 514, it is determined whether a predetermined instruction has been reached. For example, the predetermined instruction can be a store or atomic update instruction. Once this instruction has been reached, flowchart 500 proceeds to step 516.

In step 516, a respective value generated by each of the at least two lanes associated with the predetermined instruction are compared. For example, in the embodiment in which the predetermined instruction is a store instruction, the values can be a memory address to be written to or data that is to be written to that address. Thus, in step 516, the address to be written and/or the data to be written to that address may be compared. For example, in FIG. 2, comparator 216 can be used to compare the outputs of one or more of processing devices 206-212.

In some embodiments, the comparison can be effected in software instead. For example, a compiler or finalizer can insert one or more instructions into the kernel to be executed by processor 300. These one or more instructions can effect a comparison of the outputs of one or more of processing cores 206-212.

In decision step 518, it is determined whether the values match. If so, the system determines that no error is present and flowchart 500 returns to step 512 to continue processing. If the values do not match, flowchart 500 proceeds to step 520.

In step 520, an indication that a mismatch occurred is provided. In some embodiments of the present disclosure, providing the indication can include one or more actions. For example, as noted above with respect the flowchart of FIG. 4, “active” steps (e.g., raising an exception or performing majority voting) and/or “passive” steps (e.g., incrementing a counter or setting a flag) can be conducted. Moreover, as also noted above, the specific steps taken can be determined based on the request from the application and/or the instruction the triggered the comparison of generated values. For example, “active” step(s) can be taken if the triggering instruction is in one set of instructions (e.g., one or more or of the store instructions) and “passive” step(s) can be taken if the instruction is in another set of instructions (e.g., specific computations or all other instructions).

For example, as described above, based on an API presented to a software developer, the application can request an exception be raised or majority voting be conducted when an error is detected. If exception handling is selected by the application, comparator 216 can raise an exception if the values do not match. This exception can be handled by the application by, for example, returning to last point in the kernel where errors were determined not to exist. In a further embodiment, to reduce the extent of backtracking necessary when an exception is raised, the number of instructions at which values are compared can be increased.

In the majority voting, it is first determined whether a majority value is determinable, i.e. whether any value is a majority value. If so, the predetermined instruction is executed in a lane that provided the majority value. For example, in FIG. 2, if processing devices 206-210 are used for redundant processing, and processing devices 206 and 210 provide the same value and processing device 208 provides a different value, the store instruction can be executed in either of processing devices 206 and 210.

Once the exception has been handled or majority of voting has been completed, flowchart 500 returns to step 512 to execute the remaining instructions of the kernel.

As described above in FIGS. 4 and 5, wavefront level or lane level redundancy can be provided for error correction or detection. In some embodiments, both of these approaches can be combined. For example, a mirrored wavefront can be generated and two lanes can be used to execute with the same work item identifier. In some embodiments, the predetermined instruction of steps 416 and 514 can be the same instruction (e.g., a store instruction). Thus, four total values can be compared. As described above, the level of reliability provided by a redundancy approach generally increases with the amount of redundancy. Thus, by providing four values, a more reliable error check can be performed. Moreover, the four values allow for majority voting error correction.

In some embodiments, the lane level and/or wavefront level redundancy described herein is combined with other forms of error correction and/or detection. For example, in some embodiments, lane level and/or wavefront level redundancy is combined with one or more of ECC error detection and partity error detection. For example, in some embodiments, ECC error correction and error detection is used for values stored in register files 202A, 202B, 202C and 202D. The lane level and/or wavefront level redundancy, on the other hand, can be used for data path correction, i.e. the outputs of processing cores 206-12.

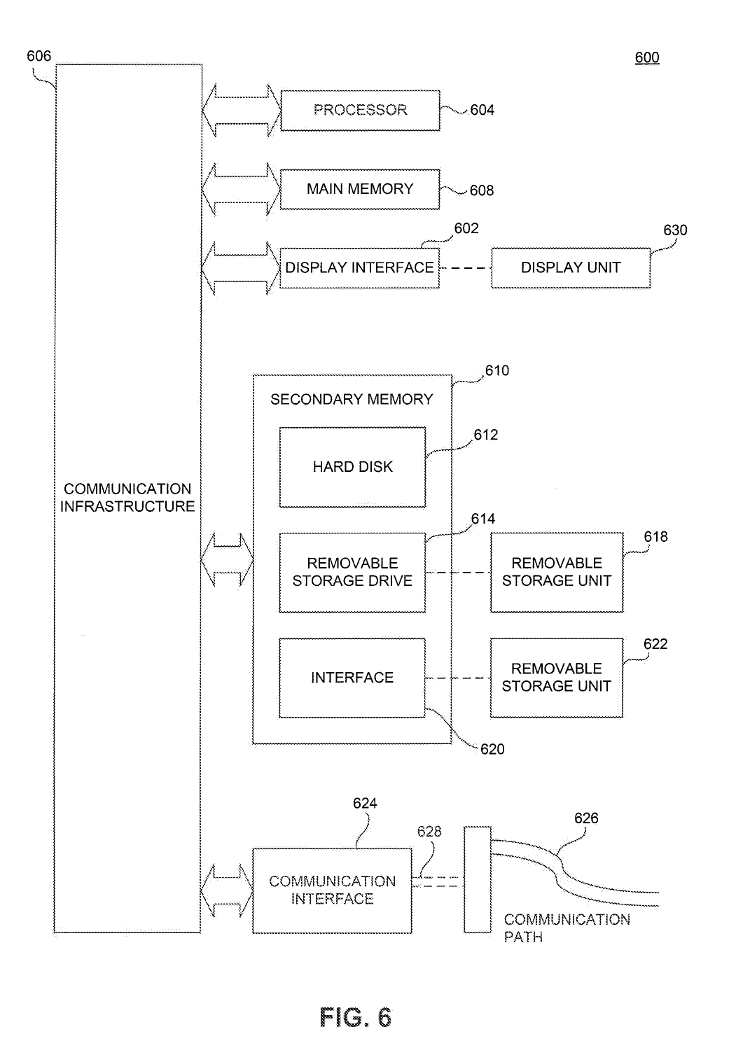

FIG. 6 illustrates an example computer system 600 in which embodiments, or portions thereof, may be implemented as computer-readable code. For example, processor 300 or portions thereof can be implemented in computer system 600 using hardware, software, firmware, tangible computer readable media having instructions stored thereon, or a combination thereof and may be implemented in one or more computer systems or other processing systems. Hardware, software, or any combination of such may embody any of the modules and components in FIGS. 2-3.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments are described in terms of this example computer system 600. After reading this description, it will become apparent to a person skilled in the relevant art how to implement embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. As will be appreciated by persons skilled in the relevant art, processor device 604 may also be a single processor in a multi-core/multiprocessor system, such system operating alone, or in a cluster of computing devices operating in a cluster or server farm. Processor device 604 is connected to a communication infrastructure 604, for example, a bus, message queue, network, or multi-core message-passing scheme.

Computer system 600 also includes a main memory 608, for example, random access memory (RAM), and may also include a secondary memory 610. Secondary memory 610 may include, for example, a hard disk drive 612, removable storage drive 614. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art, removable storage unit 618 includes a computer usable storage medium having stored therein computer software and/or data.

In some embodiments, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 can include a display interface 602 for interfacing a display unit 630 to computer system 600. Display unit 630 can be any device capable of displaying user interfaces according to this disclosure, and compatible with display interface 602. Examples of suitable displays include liquid crystal display panel based device, cathode ray tube (CRT) monitors, organic light-emitting diode (OLED) based displays, and touch panel displays. For example, computing system 600 can include a display 630 for displaying graphical user interface elements.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626. Communications path 626 carries signals and may be implemented using wire or cable, fiber optics, a phone line, a cellular phone link, a radio-frequency (RF) link or other communications channels.

In this document, the terms “computer program medium” and “computer readable medium” are used to generally refer to storage media such as removable storage unit 618, removable storage unit 622, and a hard disk installed in hard disk drive 612. Computer program medium and computer usable medium may also refer to memories, such as main memory 608 and secondary memory 610, which may be memory semiconductors (e.g. DRAMs, etc.).

Computer programs (also called computer control logic) are stored in main memory 608 and/or secondary memory 610. Computer programs may also be received via communications interface 624. Such computer programs, when executed, enable computer system 600 to implement embodiments as discussed herein. In particular, the computer programs, when executed, enable processor device 604 to implement the processes of embodiments, such as the stages of the methods illustrated by flowcharts 400 and 500. Accordingly, such computer programs can be used to implement aspects of processor 300 (e.g., aspects of scheduler 302, clusters 306, sync module 310 and/or comparator 312). Where embodiments are implemented using software, the software may be stored in a computer program product and loaded into computer system 600 using removable storage drive 614, interface 620, and hard disk drive 612, or communications interface 624.

Embodiments also may be directed to computer program products comprising software stored on any computer readable medium. Such software, when executed in one or more data processing devices, causes a data processing device(s) to operate as described herein. For example, the software can cause data processing devices to carry out the steps of flowcharts 400 and 500 shown in FIGS. 4 and 5, respectively.

Embodiments employ any computer useable or readable medium. Examples of tangible, computer readable media include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.). Other computer readable media include communication mediums (e.g., wired and wireless communications networks, local area networks, wide area networks, intranets, etc.).

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC, SystemC Register Transfer Level (RTL), and so on, or other available programs, databases, and/or circuit (i.e., schematic) capture tools. Such software can be disposed in any known computer usable medium including semiconductor, magnetic disk, optical disk (e.g., CD-ROM, DVD-ROM, etc.) and as a computer data signal embodied in a computer usable (e.g., readable) transmission medium (e.g., carrier wave or any other medium including digital, optiml, or analog-based medium). As such, the software can be transmitted over communication networks including the Internet and intranets.

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present disclosure should not be limited by any of the above-described exemplary embodiments, but should be defined only in accordance with the following claims and their equivalence.

Embodiments of the disclosed subject matter have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the contemplated embodiments that others can, by applying knowledge within the skill of the art, readily modify and/or adapt for various applications such specific embodiments, without undue experimentation, without departing from the general concept of the disclosed subject matter. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the disclosed subject matter should not be limited by any of the above-described example embodiments, but should be defined only in accordance with the following claims and their equivalents.

What is claimed is:

1. A method, comprising:
replicating input data for first and second lanes of a processor, wherein the first and second lanes are located in a same cluster of the processor and wherein the first and second lanes each generate a respective value associated with an instruction to be executed in the respective lane; and
responsive to a determination that the generated values do not match, providing an indication that the generated values do not match.

2. The method of claim 1, wherein providing an indication comprises: incrementing a counter.

3. The method of claim 1, wherein each instruction comprises a store instruction.

4. The method of claim 1, wherein providing the indication comprises:
raising an exception.

5. The method of claim 1, further comprising:
replicating the input data for a third lane of the cluster, wherein providing the indication comprises completing the instruction responsive to a determination that two of the values generated by the first, second, and third lanes match.

6. The method of claim 5, wherein completing the instruction comprises:
completing the instruction in a lane of the first, second, and third lanes whose value is equal to the majority value.

7. The method of claim 1, wherein the replicating comprises:
providing identical work-item identifiers to each of the first and second lanes.

8. The method of claim 1, wherein each of the instructions is included in a first wavefront spanning the first and second lanes, further comprising:
generating at least one mirrored wavefront having state identical to state of the first wavefront, wherein each of the first wavefront and the at least one wavefront generates a second value associated with a second instruction to be executed therein;
responsive to a determination that the second generated values do not match, providing an indication that the second generated values do not match.

9. The method of claim 8, wherein providing the indication that the second generated values do not match comprises:
raising an exception.

10. The method of claim 8, wherein the at least one wavefront comprises at least two wavefronts, further comprising:
completing the second instruction if a majority value of second generated values is determinable.

11. The method of claim 10, wherein the completing comprises:
completing the instruction in a wavefront whose respective second generated value is equal to the majority value.

12. The method of claim 1, wherein comparing comprises:
executing at least one instruction that effects a comparison of the generated values.

13. The method of claim 1, wherein the replicating and the comparing occur in response to a request for an application for high reliability.

14. The method of claim 1, wherein the value is a memory address or data to be written to the memory address.

15. A method, comprising:
generating at least one mirrored wavefront having state identical to state of a first wavefront, wherein each of the first wavefront and the at least one wavefront generates a value associated with an instruction to be executed therein; and
responsive to a determination that the generated values do not match, providing an indication that the generated values do not match.

16. The method of claim 15, wherein providing the indication comprises:
raising an exception.

17. The method of claim 15, wherein the at least one wavefront comprises at least two wavefronts and wherein the providing an indication comprises:
completing the instruction if a majority value of the generated values is determinable.

18. A system, comprising:
a scheduler configured to replicate input data for first and second lanes of a processor, wherein the first and second lanes are located in the same cluster of the processor and wherein each of the first and second lanes generates a respective value associated with an instruction to be executed in the respective lane; and
a comparator configured to compare the generated values.

19. The system of claim 18, wherein the comparator is configured to raise an exception if the values do not match.

20. A system for improving reliability in a processor, comprising:
a scheduler configured to generate at least one mirrored wavefront having state identical to state of a first wavefront, wherein each of the first wavefront and the at least one wavefront generates a value associated with an instruction to be executed therein; and
a comparator configured to compare the generated values.
